(19) United States
(12) Patent Application Publication
(10) Pub. No.: US 2026/0049950 A1
(43) Pub. Date: Feb. 19, 2026

(54) WAFER INSPECTION APPARATUS

(71) Applicant: SAMSUNG ELECTRONICS CO., LTD., Suwon-si (KR)

(72) Inventors: Hojun LEE, Suwon-si (KR); Jangwoon SUNG, Suwon-si (KR); Wookrae KIM, Suwon-si (KR); Hyungjin KIM, Suwon-si (KR); Seungbeom PARK, Suwon-si (KR)

(73) Assignee: SAMSUNG ELECTRONICS CO., LTD., Suwon-si (KR)

(21) Appl. No.: 19/064,242

(22) Filed: Feb. 26, 2025

(30) Foreign Application Priority Data
Aug. 19, 2024 (KR) 10-2024-0110760

(51) Int. Cl. G01N 21/95; G01N 21/47; G01N 21/88

(52) U.S. Cl. CPC G01N 21/9501; G01N 21/4788; G01N 21/8806; G01N 2201/0675

(57) ABSTRACT

A wafer inspection apparatus includes a light source configured to output first light, a spatial light modulator behind an image surface, the spatial light modulator configured to receive the first light and output second light that is in a random pattern, an optical system configured to provide the second light to an illuminated region of a wafer that is behind a sample surface, and a detector behind a detection surface and configured to acquire a diffraction image formed on the detection surface by reflection of the second light from a detection region within the illuminated region of the wafer, where each of the sample surface, the detection surface, and the image surface is a virtual plane that is set in a direction perpendicular to a traveling direction of the second light.

### CROSS-REFERENCE TO RELATED APPLICATION

This application is based on and claims priority to Korean Patent Application No. 10-2024-0110760, filed on Aug. 19, 2024, in the Korean Intellectual Property Office, the disclosure of which is incorporated by reference herein in its entirety.

### BACKGROUND

Example embodiments of the disclosure relate to a wafer inspection apparatus, and more particularly, to a wafer inspection apparatus for acquiring multiple diffraction images corresponding to the surface structure of a wafer.

Ptychography is a computational imaging technique for acquiring high-resolution images of an object on the basis of multiple diffraction pattern images formed by light transmitted through the object or light reflected from the object.

However, when micropatterns on the surface of an object are periodic, multiple diffraction pattern images may all be the same image. When all the diffraction pattern images are identical, high-resolution images may not be acquired based on ptychography. Therefore, there is an increasing need for a technique for acquiring different diffraction pattern images even when micropatterns on the surface of an object are periodic.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a wafer inspection apparatus that may be capable of acquiring a high-resolution image of a micropattern on the surface of a wafer.

Additional aspects will be set forth in part in the description which follows and, in part, will be apparent from the description, or may be learned by practice of the presented embodiments.

According to an aspect of an example embodiment, a wafer inspection apparatus may include a light source configured to output first light, a spatial light modulator behind an image surface, the spatial light modulator configured to receive the first light and output second light that is in a random pattern, an optical system configured to provide the second light to an illuminated region of a wafer that is behind a sample surface, and a detector behind a detection surface and configured to acquire a diffraction image formed on the detection surface by reflection of the second light from a detection region within the illuminated region of the wafer, where each of the sample surface, the detection surface, and the image surface is a virtual plane that is set in a direction perpendicular to a traveling direction of the second light, image surface is in a first light path from the light source to the spatial light modulator and in a second light path from the spatial light modulator to the optical system, and the second light that is in the random pattern forms a random pattern image of a same shape on each of the sample surface, the detection surface, and the image surface.

According to an aspect of an example embodiment, a wafer inspection apparatus may include a light source configured to output first light, a spatial light modulator behind an image surface and configured to receive the first light and output second light in a random pattern, a beam splitter in a first light path from the light source to the spatial light modulator and configured to transmit the second light toward a wafer behind a sample surface, an objective lens configured to focus the second light from the beam splitter onto an illuminated region of the wafer, and a detector behind a detection surface and configured to acquire a diffraction image formed on the detection surface based on focused third light reflected from a detection region of the wafer, where each of the sample surface, the detection surface, and the image surface is a virtual plane that is set in a direction perpendicular to a traveling direction of the second light, the image surface is in a second light path from the spatial light modulator to the beam splitter, and the second light that is in the random pattern forms a random pattern image of a same shape on each of the sample surface, the detection surface, and the image surface.

According to an aspect of an example embodiment, a wafer inspection apparatus may include a light source, a stage configured to fix a wafer that is behind a sample surface and that includes a periodic pattern formed on a surface thereof, a spatial light modulator behind an image surface and configured to receive first light from the light source and output second light in a random pattern, a beam splitter in a first path of the second light and configured to transmit the second light toward the wafer, an objective lens configured to focus the second light onto an illuminated region of the wafer, and detector behind a detection surface and configured to acquire a diffraction image formed on the detection surface based on focused third light reflected from a detection region of the wafer, where each of the sample surface, the detection surface, and the image surface is a virtual plane set in a direction perpendicular to a traveling direction of the second light in the random pattern, the image surface is in a second light path from the spatial light modulator to the beam splitter, the second light that is in the random pattern forms a random pattern image of a same shape on each of the sample surface, the detection surface, and the image surface.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a diagram illustrating a wafer inspection apparatus according to one or more embodiments;

FIG. 2 is a diagram illustrating an operation of a wafer inspection apparatus, according to one or more embodiments;

FIG. 3 is a diagram illustrating a detection region and an illuminated region of a wafer, according to one or more embodiments;

FIG. 4 is a diagram illustrating a random pattern image and a restricted region, according to one or more embodiments;

FIG. 5 is a diagram illustrating an operation of a spatial light modulator, according to one or more embodiments;

FIG. 6 is a diagram illustrating an operation of a spatial light modulator, according to one or more embodiments;

FIGS. 7A and 7B are diagrams illustrating a distance by which the position of a random pattern image moves, according to one or more embodiments;

FIG. 8 is a diagram illustrating an operation of a wafer inspection apparatus, according to one or more embodiments; and

FIG. 9 is a diagram illustrating a wafer inspection apparatus according to an embodiment.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

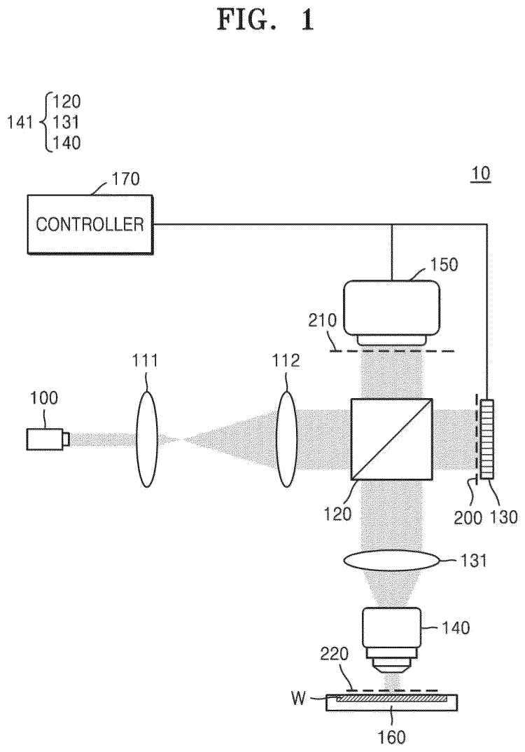

FIG. 1 is a diagram illustrating a wafer inspection apparatus 10 according to one or more embodiments.

Referring to FIG. 1, the wafer inspection apparatus 10 may include a light source 100, a first lens 111, a second lens 112, a beam splitter 120, a spatial light modulator 130, a tube lens 131, an objective lens 140, a detector 150, a stage 160, and a controller 170. The beam splitter 120, the tube lens 131, and the objective lens 140 may be collectively referred to as an optical system 141.

The light source 100 may generate and output light. The light output from the light source 100 may travel toward the first lens 111 and the second lens 112. The light source 100 may output coherent light. The coherent light may cause constructive interference or destructive interference because of a phase difference when at least two beams overlap with each other.

The light source 100 may generate and output light of various wavelengths. According to one or more embodiments, the light source 100 may generate and output light including at least one of light in a visible spectrum, light in an ultraviolet spectrum, light in an extreme ultraviolet spectrum, and light in an X-ray spectrum. In detail, the light source 100 may generate and output light obtained by combining light in the visible spectrum and light in the ultraviolet spectrum or light obtained by combining light in the ultraviolet spectrum and light in the extreme ultraviolet spectrum. In other words, the light source 100 may synthesize and output light of various wavelengths corresponding to the size and shape of a micropattern on the surface of a wafer W.

Although it is illustrated in FIG. 1 that the light output from the light source 100 directly travels to the first lens 111, a neutral density filter may be between the light source 100 and the first lens 111 and may uniformly reduce the amount of light of all wavelengths output from the light source 100.

The first lens 111 and the second lens 112 may allow light output from the light source 100 to be incident to the beam splitter 120. In detail, the first lens 111 may disperse the light output from the light source 100, and the second lens 112 may collimate the disperse light and output parallel light. The first lens 111 and the second lens 112 may change the size of the light output from the light source 100 to a size corresponding to the size of the beam splitter 120.

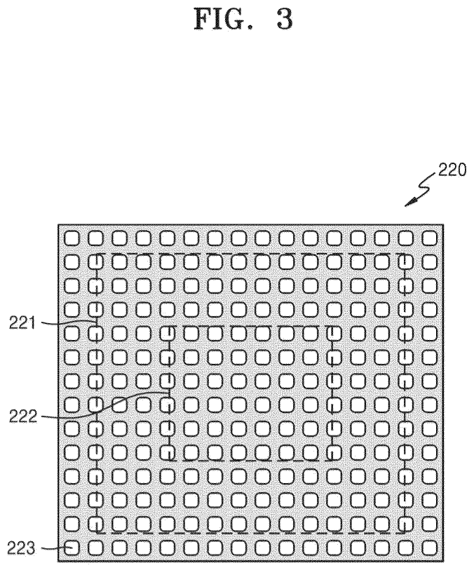

The beam splitter 120 may output light transmitted from the second lens 112 to the spatial light modulator 130 and light reflected from an illuminated region (221 in FIG. 3) of the wafer W to the detector 150. The beam splitter 120 may be positioned in a light path from the light source 100 to the spatial light modulator 130.

The beam splitter 120 may include a polarizing beam splitter. In this case, light output from the light source 100 may be in a polarization state in which the light may be transmitted through the polarizing beam splitter when incident to the polarizing beam splitter at an incident angle of 45 degrees. Light output from the spatial light modulator 130 may be in a polarization state in which the light may be reflected from the polarizing beam splitter when incident to the polarizing beam splitter at an incident angle of 45 degrees.

As described above, the beam splitter 120 may include a polarizing beam splitter, but embodiments are not limited thereto. The beam splitter 120 may include various kinds of beam splitters, such as a non-polarizing beam splitter and a variable beam splitter, which may transmit light from the light source 100 to the spatial light modulator 130 and transmit light from the spatial light modulator 130 to the wafer W.

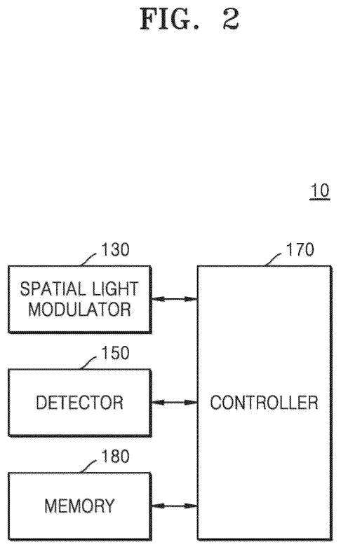

The spatial light modulator 130 may receive light output from the light source 100 and may output light in a random pattern. The spatial light modulator 130 may be implemented as a reflective spatial light modulator or a transmissive spatial light modulator. However, the descriptions of FIGS. 1 and 2 correspond to the case where the spatial light modulator 130 is implemented as a reflective spatial light modulator, which receives light from the light source 100 and outputs reflective light in a random pattern, and embodiments are not limited thereto.

The spatial light modulator 130 may include a plurality of light modulation pixels. Each of the light modulation pixels may independently receive a control signal and may modulate, based on the control signal, the phase and/or amplitude of light input to each light modulation pixel.

According to one or more embodiments, the spatial light modulator 130 may include 1920×1080 light modulation pixels. A phase modulation value and/or a amplitude modulation value may be arbitrarily assigned to each of the 1920×1080 light modulation pixels, and the phase and/or amplitude of light input to the spatial light modulator 130 may be respectively modulated by the phase modulation value and/or the amplitude modulation value before the light is output from the spatial light modulator 130.

Light modulation pixels may include various elements, such as a liquid crystal display (LCD) device, a digital micromirror device (DMD), a deformable mirror, an optical grating, and a diffraction optical element, which are capable of modulating the phase and/or amplitude of input light.

Although it has been described above that light modulation pixels are arranged 1920×1080, embodiments are not limited thereto. Light modulation pixels may be arranged in various forms, such as 1280×720 and 640×480.

As described above, the spatial light modulator 130 may output light in a random pattern by using a plurality of light modulation pixels each independently receiving a control signal. Here, the light in a random pattern may form a random pattern image on an image surface 200, a detection surface 210, and a sample surface 220.

The random pattern image may include an image having an irregular phase distribution and/or an irregular amplitude distribution throughout the area of the image. For example, the random pattern image may include a speckle pattern image. The spatial light modulator 130 may move the position of the random pattern image on the image surface 200. When the position of the random pattern image is changed on the image surface 200, the position of the random pattern image on each of the detection surface 210 and the sample surface 220 may also be correspondently changed. The positional movement of the random pattern image is described below with reference to FIGS. 2 to 6.

The tube lens 131 may transmit light, which travels from the beam splitter 120 toward the wafer W, to the objective lens 140. The tube lens 131 may collimate light or converge light to form an image at an appropriate magnification.

The objective lens 140 may focus light from the tube lens 131 onto the illuminated region (221 of FIG. 3) of the wafer W. Together with the tube lens 131, the objective lens 140 may form a 4F optical system 141 with respect to the wafer W. Here, the 4F optical system 141 may refer to a system in which the distance between two lenses is equal to the sum of focal lengths of the two lenses.

According to one or more embodiments, the focal length of the tube lens 131 may be f₁ and the focal length of the objective lens 140 may be f₂. In this case, the distance between the tube lens 131 and the objective lens 140, which form a 4F optical system 141, may be f₁+f₂.

As described above, because the objective lens 140 and the tube lens 131 form a 4F optical system 141, images of the same shape may be respectively formed on the image surface 200 in front of the spatial light modulator 130, the detection surface 210 in front of the detector 150, and the sample surface 220 in front of the stage 160. Here, images being of the same shape may indicate that the images have the same overall shape (e.g., a square) but may have different sizes (e.g., different square sizes). Because the focal lengths of the tube lens 131 and the objective lens 140, which form a 4F optical system 141, are different, an image may be formed on the image surface 200, the detection surface 210, and the sample surface 220 at different magnifications.

According to one or more embodiments, when the focal length of the tube lens 131 is f₁ and the focal length of the objective lens 140 is f₂, the size of a random pattern image formed on the image surface 200 may be S₁. In this case, the size of a random pattern image, which is formed on the sample surface 220 and has the same shape as the random pattern image on the image surface 200, may be as in Equation (1).

$${S}_{2} = \frac{{f}_{2}}{{f}_{1}} {S}_{1} \qquad ( 1 )$$

In other words, although the size of a random pattern image may be different among the image surface 200, the detection surface 210, and the sample surface 220 according to the focal lengths of lenses of a 4F optical system 141, the shape of the random pattern image may not change.

Here, each of the image surface 200, the detection surface 210, and the sample surface 220 may be a virtual plane set in a direction that is perpendicular to the traveling direction of light of a random pattern. That is, the surfaces may be set as a two-dimensional (2D) plane, and the light path may be perpendicular to a surface of the 2D plane. For example, the image surface 200 may be a plane, which is in a light path from the spatial light modulator 130 to the beam splitter 120 and perpendicular to the traveling direction of light of a random pattern from the spatial light modulator 130 toward the beam splitter 120.

Although it is illustrated in FIG. 1 that the image surface 200, the detection surface 210, and the sample surface 220 are respectively spaced apart from the spatial light modulator 130, the detector 150, and the wafer W, embodiments are not limited thereto. The image surface 200 may be a plane that coincides with the front of the spatial light modulator 130, the detection surface 210 may be a plane that coincides with the front of the detector 150, and the sample surface 220 may be a plane that coincides with the top surface of the wafer W.

The illuminated region (221 of FIG. 3) of the wafer W on which the objective lens 140 focuses light may be fixed. In other words, the illuminated region (221 of FIG. 3) of the wafer W may not change even when the position of a random pattern image changes.

As described above, the beam splitter 120, the tube lens 131, and the objective lens 140 may be collectively referred to as the optical system 141. Furthermore, the optical system 141 may also generally refer to a plurality of elements that provide light of a random pattern from the spatial light modulator 130 to the illuminated region of the wafer W. The optical system 141 may also transmit light reflected from the illuminated region (221 of FIG. 3) of the wafer W to the detector 150.

The optical system 141 may further include a quarterwave plate, a polarizer, a relay lens, etc. in addition to the beam splitter 120, the tube lens 131, and the objective lens 140. The functions of the optical system 141 are not limited to those described above. The optical system 141 may perform various functions such as a function of transmitting light from the light source 100 to the spatial light modulator 130 and a function of adjusting a magnification to an appropriate value.

The detector 150 may be behind the detection surface 210 and may acquire a diffraction image formed on the detection surface 210 by light reflected from the detection region (222 of FIG. 3) of the wafer W. Here, the detection region (222 of FIG. 3) of the wafer W may be on the same plane as the illuminated region (221 of FIG. 3) of the wafer W and may be within the illuminated region (221 of FIG. 3) of the wafer W. In other words, the illuminated region (221 of FIG. 3) of the wafer W may refer to a region in which light focused by the objective lens 140 is incident to the sample surface 220, and the detection region (222 of FIG. 3) of the wafer W may be a region, which is within the illuminated region (221 of FIG. 3) of the wafer W and in which a diffraction image acquired by the detector 150 is generated. The illuminated region (221 of FIG. 3) and the detection region (222 of FIG. 3) of the wafer W are described in detail with reference to FIG. 3.

The detector 150 may include various kinds of detection devices, such as charge-coupled device (CCD), a complementary metal-oxide semiconductor (CMOS) device, and a photomultiplier tube (PMT), which may acquire a 2D diffraction image that light reflected from the detection region of the wafer W formed on the detection surface 210.

The stage 160 may be behind the sample surface 220 and may support and fix the wafer W. For example, the wafer W may be on the top surface of the stage 160, and the stage 160 may support and fix the bottom surface of the wafer W. The wafer W fixed by the stage 160 may include a periodic pattern on the surface thereof.

The controller 170 may be connected to the spatial light modulator 130 and the detector 150, and may control the spatial light modulator 130 and the detector 150. Operations of the controller 170 controlling the spatial light modulator 130 and the detector 150 are described in detail with reference to FIG. 2 below.

FIG. 2 is a diagram illustrating an operation of the wafer inspection apparatus 10, according to one or more embodiments.

Referring to FIG. 2, the wafer inspection apparatus 10 may include the controller 170, the spatial light modulator 130, the detector 150, and a memory 180. However, the configuration of the wafer inspection apparatus 10 is not limited to that described above. The wafer inspection apparatus 10 may include more elements and is not limited to those mentioned above. The functions of the spatial light modulator 130 and the detector 150 have been described above, and descriptions thereof may be omitted.

The memory 180 may store a program for the processing and controlling operations of the controller 170 and data input to or output from the wafer inspection apparatus 10. The memory 180 may also store information about the position of a random pattern image formed on the image surface 200 and a diffraction image acquired by the detector 150.

The memory 180 may include at least one type of storage media among a flash memory type, a hard disk type, a multimedia card micro type, a card-type memory (e.g., secure digital (SD) or extreme digital (XD) memory), random-access memory (RAM), static RAM (SRAM), read-only memory (ROM), electrically erasable programmable ROM (EEPROM), programmable ROM (PROM), magnetic memory, a magnetic disk, and an optical disk.

The controller 170 may be operatively connected to the spatial light modulator 130, the detector 150, and the memory 180 and may generally control operations of the wafer inspection apparatus 10. The controller 170 may include at least one of a microprocessor, a digital signal processor, and similar processing devices.

The controller 170 may control the spatial light modulator 130 to output light of a random pattern such that a random pattern image is formed on the image surface 200, the detection surface 210, and the sample surface 220.

According to one or more embodiments, the spatial light modulator 130 may include a plurality of light modulation pixels. The controller 170 may assign an arbitrary phase modulation value to each of the light modulation pixels. The arbitrary phase modulation value may be arbitrarily selected from values of 0 to 2. In detail, the controller 170 may assign a phase modulation value of 0.5 to a light modulation pixel at coordinates (100, 200) in a 2D x-y coordinate system, in which the positions of a plurality of light modulation pixels are plotted, and a phase modulation value of 1.43 to a light modulation pixel at coordinates (200, 100) in the 2D x-y coordinate system. In this case, the phase of light input to the light modulation pixel at the coordinates (100, 200) may be modulated by 0.5 before the light is output from the spatial light modulator 130, and the phase of light input to the light modulation pixel at the coordinates (200, 100) may be modulated by 1.43 before the light is output from the spatial light modulator 130.

As described above, the controller 170 may independently and arbitrarily assign a phase modulation value to each light modulation pixel, thereby controlling light of a random pattern to be output from the spatial light modulator 130.

Although it has only been described above that the controller 170 arbitrarily assigns a phase modulation value to each light modulation pixel, the controller 170 may also arbitrarily assign an amplitude modulation value to each light modulation pixel. The controller 170 may arbitrarily assign a phase modulation value and an amplitude modulation value to each light modulation pixel such that both the phase and amplitude of light input to the spatial light modulator 130 may be modulated.

The controller 170 may arbitrarily assign a phase modulation value and an amplitude modulation value to each of light modulation pixels only in a region corresponding to the position of a random pattern image on the image surface 200 among a plurality of light modulation pixels. Here, when the position of the random pattern image is changed, the light modulation pixels to which phase modulation values and/or amplitude modulation values are assigned may be changed.

According to one or more, when the position of a random pattern image on the image surface 200 (hereinafter, referred to as the position of a random pattern image) is a first position, the controller 170 may arbitrarily assign a phase modulation value and/or an amplitude modulation value to each of light modulation pixels only in a region corresponding to the first position. When the position of the random pattern image is changed from the first position to a second position, the controller 170 may assign the phase modulation value and/or the amplitude modulation value, which has been assigned to each of the light modulation pixels in the region corresponding to the first position, to each of light modulation pixels in a region corresponding to the second region.

The controller 170 may map and store a diffraction image and information about the position of a formation region of a random pattern image in the memory 180.

According to one or more embodiments, in the case where a diffraction image acquired by the detector 150 when the position of a formation region of a random pattern image is the first position is a first diffraction image, the controller 170 may map and store the first diffraction image and information about the first position in the memory 180.

Here, the information about the first position may be stored as 2D spatial coordinates (e.g., (x₁, y₁)). The information about the first position may be stored as 2D frequency coordinates (e.g., (kₓ, k_{y})). 2D frequency coordinates may refer to a 2D frequency coordinate value generated by performing a Fourier transform on a 2D spatial coordinate value.

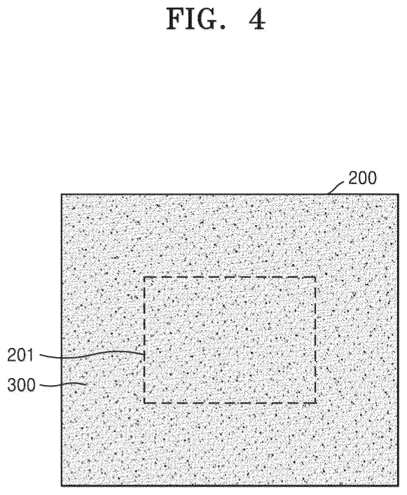

The controller 170 may control the spatial light modulator 130 such that the position of a random pattern image is changed based on various rules and may control the detector 150 to acquire a diffraction image corresponding to a changed position whenever the position of the random pattern image is changed. The control method of the controller 170 is described in detail with reference to FIGS. 4 to 8 below.

According to one or more embodiments, the wafer inspection apparatus 10 may include the elements described above, thereby changing the position of a random pattern image on the image surface 200. As the position of the random pattern image on the image surface 200 is changed, the position of the random pattern image on the sample surface 220 may also be changed. Accordingly, the wafer inspection apparatus 10 may acquire multiple diffraction images without changing the illuminated region of the wafer W fixed on the stage 160.

In other words, the wafer inspection apparatus 10 may acquire multiple different diffraction images by controlling the spatial light modulator 130 such that the position of a random pattern image is changed, without moving the position of the wafer W. As a result, the wafer inspection apparatus 10 may acquire a high-resolution image corresponding to the surface of the wafer W even when the wafer W includes a periodic pattern on the surface thereof.

FIG. 3 is a diagram illustrating a detection region and an illuminated region of the wafer W, according to one or more embodiments.

Referring to FIG. 3, on the sample surface 220, a detection region 222 of the wafer W may be within an illuminated region 221 of the wafer W, on which light is focused by the objective lens 140.

As shown in FIG. 3, the wafer W may include a periodic pattern on the surface thereof. Here, the periodic pattern may refer to an arrangement of structures regularly repeated on a surface.

According to one or more embodiments, the wafer W may include a plurality of copper pads 223 regularly repeated on the surface thereon. Here, the copper pads 223 may be provided for the bonding to another semiconductor chip and may have a structure including copper dishing. The pads 223 may be arranged in the periodic pattern (i.e., the arrangement of the pads may correspond to the periodic pattern of the arrangement of structures on the surface of the wafer W).

Although it has been described above that the periodic pattern on the surface of the wafer W is the structure of copper pads 223, embodiments are not limited thereto. The periodic pattern on the surface of the wafer W may include various repeating structures, such as a structure of a plurality of regularly arranged vias, a structure of a plurality of electrodes, and a structure of a plurality of trenches.

Light focused by the objective lens 140 may be reflected from the illuminated region 221. The light reflected from the illuminated region 221 may be incident to the detector 150 through the objective lens 140, the tube lens 131, and the beam splitter 120. The detector 150 may acquire a diffraction image formed on the detection surface 210 by light reflected from the detection region 222 within the illuminated region 221.

FIG. 4 is a diagram illustrating a random pattern image 300 and a restricted region 201, according to one or more embodiments.

As shown in FIG. 4, light output from the light source 100 may be incident to the entire area of the spatial light modulator 130. The spatial light modulator 130 may output light in a random pattern by modulating the phase and/or amplitude of the light incident to the entire area of the spatial light modulator 130. The light in a random pattern may form a random pattern image 300 on the image surface 200.

The restricted region 201 may refer to a virtual region set on the image surface 200. In detail, the restricted region 201 may refer to a virtual region which is set on the image surface 200 to correspond to the position, shape, and size of the detection region 222 on the sample surface 220.

As a non-limiting example for the purposes of explanation, the illuminated region 221 of the sample surface 220 may measure 100 μm by 100 μm and the detection region 222 may measure 10 μm by 10 μm at the center of the illuminated region 221. In this case, when the random pattern image 300 formed on the image surface 200 measures 100 μm by 100 μm, the restricted region 201 may measure 10 μm by 10 μm at the center of the random pattern image 300.

Although the case where each of the illuminated region 221, the detection region 222, and the restricted region 201 has a rectangular shape is illustrated in the figures, embodiments are not limited thereto. Each of the illuminated region 221, the detection region 222, and the restricted region 201 may have various shapes, such as a circle, an oval, and a parallelogram.

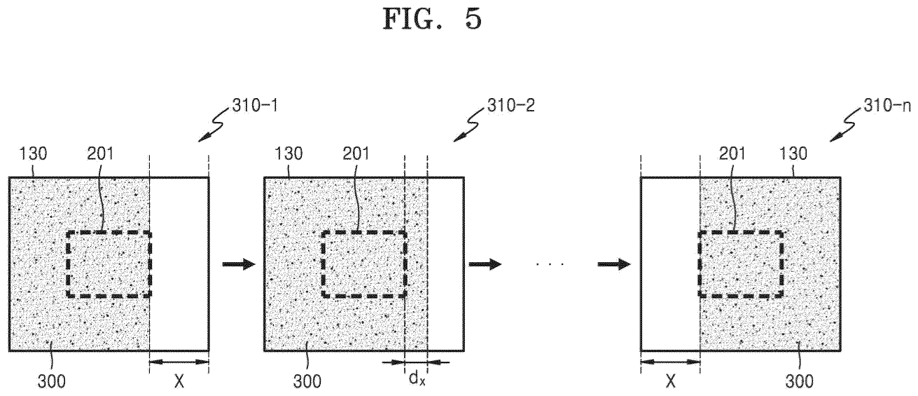

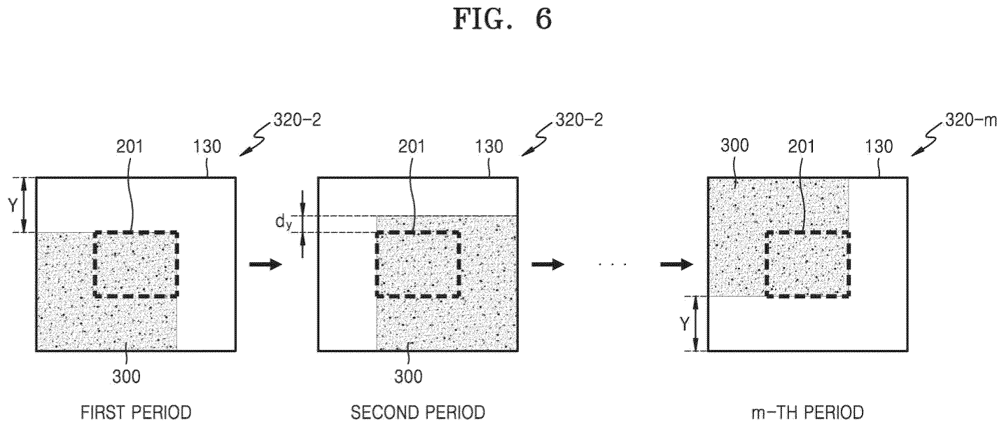

The position of the random pattern image 300 may be moved within a preset region. The preset region may indicate a region of movement of the position of the random pattern image 300. For example, the random pattern image 300 may move only within a region that allows the restricted region 201 to be included within the random pattern image 300 formed on the image surface 200, and this region may correspond to the preset region. In one or more embodiments, the random pattern image 300 may move within a region that allows for the restricted region 201 to be fully included within the random pattern image 300 formed on the image surface 200. The movement of the position of the random pattern image 300 within the preset region is described in detail with reference to FIGS. 5 and 6 below.

FIG. 5 is a diagram illustrating an operation of the spatial light modulator 130, according to one or more embodiments.

Referring to FIG. 5, the position of a random pattern image formed on the image surface 200 may be moved to laterally during any one of a plurality of periods.

According to one or more embodiments, as shown in FIG. 5, the position of a formation region of a random pattern image may be moved laterally by a first distance dₓ n times during one period. Here, one period may include n steps.

In a first step of one period, the random pattern image 300 may be in a first position 310-1. The first position 310-1 may be a position to which the random pattern image has moved to the left by a maximum range within a preset region. That is, the first position 310-1 may be a position to which the random pattern image 300 has moved to the left by a maximum amount of lateral distance X in which the restricted region 201 is still fully included within the random pattern image 300, such that, if the random pattern image 300 were to be moved to the left by any further amount of distance, a portion of the restricted region 201 may be outside of the random pattern image 300. In a second step of one period, the random pattern image 300 may be in a second position 310-2. The second position 310-2 may be a position moved to the right by the first distance dₓ from the first position 310-1. In an n-th step of one period, the random pattern image 300 may be in an n-th position 310-n. The n-th position 310-n may be a position moved to the right by the first distance dₓ “n” times from the first position 310-1. That is, the n-th position 310-n may be a position to which the random pattern image 300 has moved to the right by a maximum amount of lateral distance X in which the restricted region 201 is still fully included within the random pattern image 300, such that, if the random pattern image 300 were to be moved to the right by any further amount of distance, a portion of the restricted region 201 may be outside of the random pattern image 300.

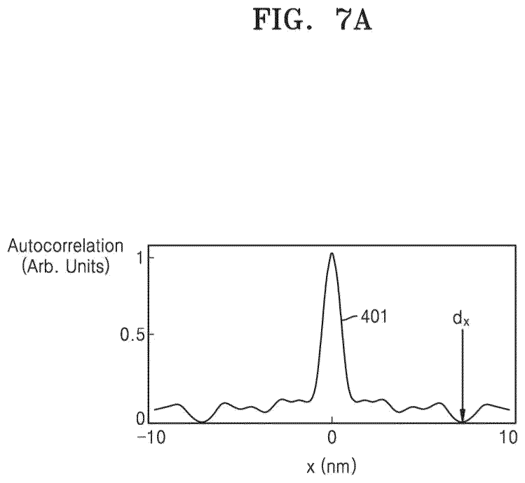

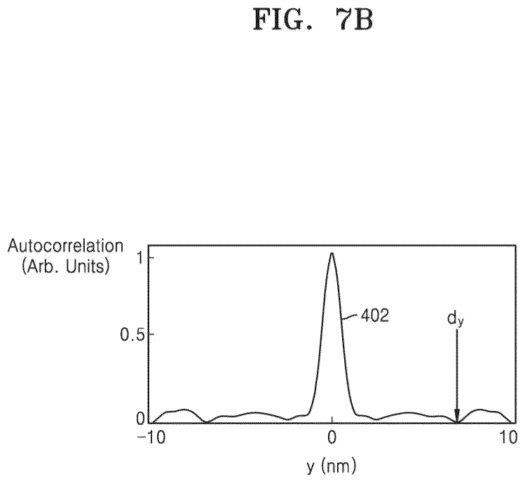

As described above, a random pattern image 300 may be moved to the laterally by the first distance dₓ “n” times during one of a plurality of periods. Here, the first distance dₓ may be determined based on an auto-correlation function of the random pattern image. This is described in detail with reference to FIGS. 7A and 7B below.

As shown in FIG. 5, in a plurality of steps of one period, the size of a random pattern image formed on the image surface 200 may be changed. Referring back to FIG. 4, the size of the random pattern image 300 may be the same as the size of a region in which a plurality of light modulation pixels of the spatial light modulator 130 are distributed. Accordingly, when the random pattern image 300 is moved laterally or moved vertically, a random pattern image with a left, right, upper, or lower portion deleted may be formed on the image surface 200. For example, as shown in FIG. 5, when a random pattern image is in the first position 310-1, the random pattern image 300 has been moved to the left by X compared to when the random pattern image 300 is at the center of the image surface 200, and accordingly, the random pattern image with a left portion deleted may be formed on the image surface 200.

Although it is illustrated in FIG. 5 that the position of the random pattern image 300 is moved laterally by the maximum range in the first to n-th steps of one period, embodiments are not limited thereto. For example, as shown in FIG. 4, the position of a random pattern image 300 may be the center of the image surface 200 in the first step of one period. The position of the random pattern image 300 in the n-th step of one period may be a position moved laterally by the first distance dₓ from the center of the image surface 200.

A plurality of periods may include different numbers of steps. For example, a first period may include n1 steps and a second period may include n2 steps, where n2>n1.

FIG. 6 is a diagram illustrating an operation of the spatial light modulator 130 according to one or more embodiments.

Referring to FIG. 6, the position of a random pattern image 300 formed on the image surface 200 may be moved vertically when one period changes to the next.

According to one or more embodiments, as shown in FIG. 6, when one period changes to the next, the position of the random pattern image may be moved upward once by a second distance d_{y}. In this case, a plurality of periods may include “m” periods.

In the first period, the position of the random pattern image may be at a first level 320-1. The first level 320-1 may be a level at which the position of the random pattern image 300 is after moving downward by a maximum range Y within a preset region. That is, the first level 320-1 may be a level to which the random pattern image 300 has moved downward by a maximum amount of vertical distance Y in which the restricted region 201 is still fully included within the random pattern image 300, such that, if the random pattern image 300 were to be moved downward by any further amount of distance, a portion of the restricted region 201 may be outside of the random pattern image 300. In the second period, the position of the random pattern image 300 may be at a second level 320-2. The second level 320-2 may be a level at which the position of the random pattern image 300 is after moving upward from the first level 320-1 by the second distance d_{y}. In the m-th period, the position of the random pattern image 300 may be at an m-th level 320-m. The m-th level 320-m may be a level at which the position of the random pattern image 300 is after moving upward “m” times from the first level 320-1 by the second distance d_{y}. That is, the level 320-m may be a level to which the random pattern image 300 has moved upward by a maximum amount of vertical distance Y in which the restricted region 201 is still fully included within the random pattern image 300, such that, if the random pattern image 300 were to be moved upward by any further amount of distance, a portion of the restricted region 201 may be outside of the random pattern image 300.

For example, the position of a random pattern image 300 may move “n” times to the right by the first distance dₓ at the first level 320-1 in the first period and may move “n” times to the right by the first distance dₓ at the m-th level 320-1 in the m-th period.

When the position of a random pattern image 300 moves “n” times to the right at the first level 320-1 in the first period, the position of the random pattern image 300 moves “n” times to the left at the second level 320-2 in the second period. In other words, the position of the random pattern image 300 in the last step of the first period may be reached after the random pattern image 300 moves to the right by the maximum range at the first level 320-1. In this case, as the first period changes to the second period, the position of the random pattern image 300 only moves upward by the second distance d_{y}. Accordingly, the position of the random pattern image 300 in the first step of the second period may be a position reached after the random pattern image 300 moves to the right by the maximum range at the second level 320-2. Accordingly, in the second period, the position of the random pattern image 300 may move “n” times to the left at the second level 320-2.

Put alternatively, the maximum lateral distance on both lateral sides in which the restricted region 201 is still included in the random pattern image 300 may be given as X as shown in FIG. 5, and the maximum vertical distance on both vertical sides in which the restricted region 201 is still included in the random pattern image 300 may be given as Y as shown in FIG. 6. At the start of a first period, the random pattern image 300 may be at a first vertical level at which the restricted region 201 is fully included, and at a first horizontal position at which the restricted region 201 is fully included, as shown in 320-1 of FIG. 6. The random pattern image 300 may be at a maximum lateral distance X from the left side and at a maximum vertical distance Y from the top side. During the first period, the random pattern image 300 may be moved laterally in steps by predetermined lateral increments (e.g., dₓ) from one lateral end to another lateral end at which the restricted region 201 is fully included until the random pattern image 300 is at a maximum lateral distance X from the right side, as shown by the lateral position in the second period view of FIG. 6. Then, the random pattern image 300 may be moved vertically by a predetermined vertical increment (e.g., d_{y}), and during the second period, the random pattern image 300 may be moved laterally in steps by the predetermined lateral increments (e.g., dₓ) from the left side to the right side. Then, when the random pattern image 300 is at a maximum lateral distance X from the left side, the random pattern image 300 may be moved vertically by the predetermined vertical increment (e.g., d_{y}). This process may be repeated until the random pattern image 300 is transmitted at all positions within the predetermined vertical increments and predetermined horizontal increments within the maximum distances X and Y such that the restricted region 201 is included in all transmissions. Furthermore, embodiments are not limited thereto, and the random pattern image 300 may be moved vertically by the predetermined vertical increments while being horizontally fixed through each period (i.e., the directionally opposite operation as that shown in FIGS. 5 and 6).

As described above, a random pattern image 300 may move vertically by the second distance d_{y} as one period changes to the next. Here, the second distance d_{y} may be determined based on an auto-correlation function of the random pattern image 300.

As described with reference to FIGS. 5 and 6, the position of a random pattern image 300 may move by a first distance or a second distance within a preset region. In other words, the preset region may be defined by +/−the maximum distance X and +/−the maximum distance Y. As a result, the random pattern image may be provided at a plurality of positions within the preset region.

FIGS. 7A and 7B are diagrams illustrating a distance by which the position of a random pattern image moves, according to one or more embodiments.

FIG. 7A is a graph of an x-axis autocorrelation function 401 of a random pattern image, according to one or more embodiments. FIG. 7B is a graph of a y-axis autocorrelation function 402 of a random pattern image, according to one or more embodiments.

Here, the autocorrelation function of a random pattern image may refer to a function representing spatial correlation between distributions of intensity or intensity values of a random pattern image formed on the image surface 200.

The first distance dₓ and the second distance d_{y} may be determined based on the autocorrelation function of a random pattern image. For example, the first distance dₓ may correspond to an x-value of a point at which the graph of the x-axis autocorrelation function 401 has a minimum value, and the second distance d_{y} may correspond to a y-value of a point at which the graph of the y-axis autocorrelation function 402 has a minimum value.

According to one or more embodiments, each of the first distance dₓ and the second distance d_{y} may be 9 nm. In this case, the position of a random pattern image may move “n” times to the left or right by 9 nm in one period. As one period changes to the next, the position of the random pattern image may move once downward and upward by 9 nm.

Here, the number of steps, n, included in one period may be determined based on the size of a preset region and the size of the first distance. Referring back to FIG. 5, because the position of a random pattern image may move only within the preset region, the position of the random pattern image may move to the right by 2X during one period. Here, because the size of the first distance is dₓ, the number of steps, n, included in one period may be determined as 2X/dₓ.

The number of periods, m, may be determined based on the size of the preset region and the size of the second distance. Referring back to FIG. 6, because the position of a random pattern image may move only within the preset region, the position of the formation region of the random pattern image may move upward by 2Y during the plurality of periods. Here, because the size of the second distance is d_{y}, the number of periods, m, may be determined as 2Y/d_{y}.

Although it has been described with reference to FIGS. 5 to 7B that the positional movement of the formation region of a random pattern image may be continuously performed over a plurality of periods, embodiments are not limited thereto. The positional movement of the formation region may be arbitrarily performed.

According to one or more embodiments, the controller 170 may divide the preset region into n*m regions based on the first distance dₓ and the second distance d_{y}. The controller 170 may control the spatial light modulator 130 to arbitrarily move the position of a random pattern image to the positions of the n*m regions. For example, the controller 170 may control the spatial light modulator 130 to move the position of a random pattern image in a diagonal direction such that the random pattern image may be located in the positions of the n*m regions one by one in random order.

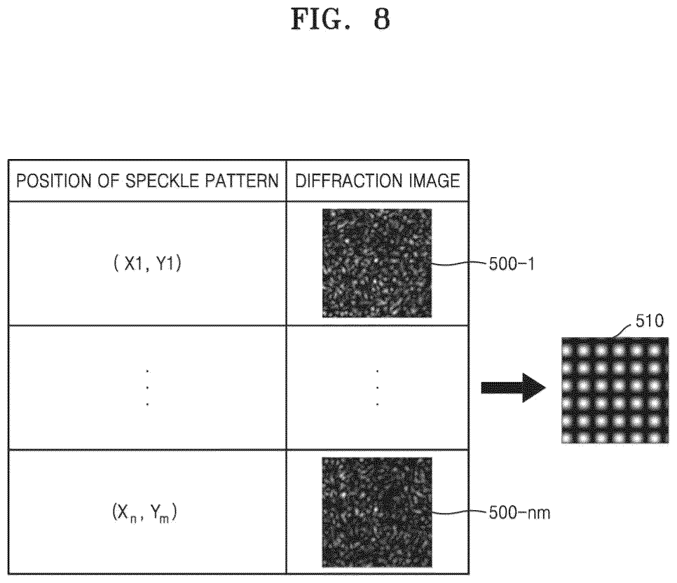

As described above, the position of a random pattern image may be moved a total of n*m times, and the detector 150 may acquire n*m diffraction images. The n*m positions of the random pattern image and the n*m diffraction images may be stored in the memory 180, which is described in detail with reference to FIG. 8 below.

FIG. 8 is a diagram illustrating an operation of the wafer inspection apparatus 10, according to one or more embodiments.

Referring to FIG. 8, the wafer inspection apparatus 10 may acquire a high-resolution image 510 of the surface of the wafer W, based on information about a plurality of positions of a random pattern image formed on the image surface 200 and a plurality of diffraction images (e.g., 500-1 to 500-nm).

According to one or more embodiments, the position of a random pattern image formed on the image surface 200 may be moved from a first position (e.g., (X1, Y1)) to an n×m-th position (e.g., (Xₙ, Yₘ)). The detector 150 may acquire a plurality of diffraction images respectively corresponding to a plurality of positions. For example, the detector 150 may acquire a first diffraction image 500-1 when the position of the random pattern image is the first position (e.g., (X1, Y1)) and may acquire an n×m-th diffraction image 500-nm when the position of the random pattern image is the n×m-th position.

The controller 170 may map and store a plurality of diffraction images and information about a plurality of positions, respectively, in the memory 180. For example, the controller 170 may map and store the first diffraction image 500-1 and information about the first position and the n×m-th diffraction image 500-nm and information about the n×m-th position in the memory 180.

Here, the information about the first position to information about the n×m-th position may be stored as 2D spatial coordinates, as shown in FIG. 8. Information about a plurality of positions may also be stored as 2D frequency coordinates. In this case, a Fourier transform by which 2D spatial coordinates are transformed to 2D frequency coordinates may be performed by the controller 170.

The controller 170 may input a plurality of diffraction images (e.g., 500-1 to 500-nm) and information about a plurality of positions, which are mapped and stored in the memory 180, into a computational imaging algorithm and may acquire the high-resolution image 510. Here, the computational imaging algorithm may receive a plurality of low-resolution images acquired by a detector and may output a high-resolution image. The computational imaging algorithm may include various algorithms, such as an iterative Fourier transform algorithm (IFTA) and an algebraic reconstruction technique (ART). The computational imaging algorithm described above may be stored in the memory 180.

Although it has been described that the controller 170 may acquire the high-resolution image 510 by directly executing the computational imaging algorithm, embodiments are not limited thereto. The controller 170 may transmit a plurality of diffraction images and information about a plurality of positions, which are mapped and stored in the memory 180, to an external device that may execute a computational imaging algorithm and may acquire the high-resolution image 510 from the external device.

The wafer inspection apparatus 10 may provide an analysis result with respect to a periodic pattern on the surface of the wafer W, based on the high-resolution image 510 that has been acquired.

According to one or more embodiments, the wafer inspection apparatus 10 may provide information about a surface step of the wafer W, based on the high-resolution image 510 acquired through a computational imaging algorithm. For example, the wafer inspection apparatus 10 may provide information about steps of a plurality of copper pads 223 which are regularly arranged on the surface of the wafer W.

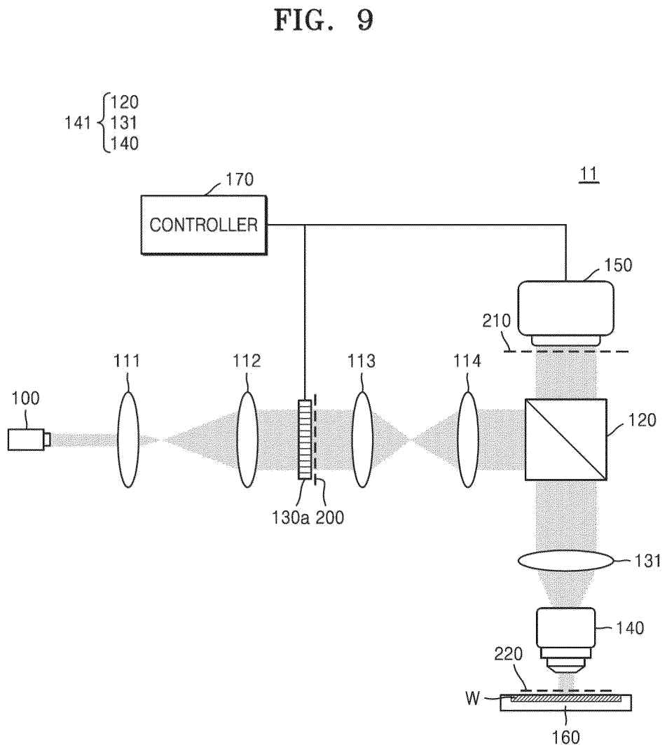

FIG. 9 is a diagram illustrating a wafer inspection apparatus 11 according to one or more embodiments.

Description of aspects that have been made with reference to FIGS. 1 and 2 may be omitted.

Referring to FIG. 9, the wafer inspection apparatus 11 may include a third lens 113 and a fourth lens 114. A spatial light modulator 130a may be in a light path from the light source 100 to the beam splitter 120. In other words, the beam splitter 120 may be in a path of transmitted light output from the spatial light modulator 130a.

Light output from the light source 100 may be transmitted through the spatial light modulator 130a. In other words, the spatial light modulator 130a may include a transmissive spatial light modulator. In this case, a phase modulation value and/or an amplitude modulation value may be arbitrarily assigned to each of a plurality of light modulation pixels of the spatial light modulator 130a. Accordingly, transmitted light transmitted through the spatial light modulator 130a may correspond to transmitted light having a random pattern, which results from phase and/or amplitude modulation by the spatial light modulator 130a.

The transmitted light in a random pattern, which is output from the spatial light modulator 130a, may be incident to the third lens 113 and the fourth lens 114. The third lens 113 and the fourth lens 114 may form a 4F optical system 141. A transmitted light in a random pattern, which has been transmitted through the fourth lens 114, may be incident to the beam splitter 120. The beam splitter 120 may transmit the transmitted light in the random pattern toward the wafer W. Random pattern images having the same shape may be respectively formed on the image surface 200, the detection surface 210, and the sample surface 220.

According to one or more embodiments, even when including a transmissive spatial light modulator, the wafer inspection apparatus 11 may acquire a plurality of diffraction images of the surface of the wafer W and may acquire a high-resolution image corresponding to the surface of the wafer W based on the diffraction images.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A wafer inspection apparatus comprising:
a light source configured to output first light;
a spatial light modulator behind an image surface, the spatial light modulator configured to receive the first light and output second light that is in a random pattern;
an optical system configured to provide the second light to an illuminated region of a wafer that is behind a sample surface; and
a detector behind a detection surface and configured to acquire a diffraction image formed on the detection surface by reflection of the second light from a detection region within the illuminated region of the wafer,
wherein each of the sample surface, the detection surface, and the image surface is a virtual plane that is set in a direction perpendicular to a traveling direction of the second light,
wherein the image surface is in a first light path from the light source to the spatial light modulator and in a second light path from the spatial light modulator to the optical system, and
wherein the second light that is in the random pattern forms a random pattern image of a same shape on each of the sample surface, the detection surface, and the image surface.

2. The wafer inspection apparatus of claim 1, further comprising a controller configured to control the spatial light modulator to move a position of the random pattern image on the image surface,
wherein the illuminated region of the wafer and the detection region within the illuminated region are not changed while the position of the random pattern image is moved.

3. The wafer inspection apparatus of claim 2, wherein the image surface comprises a restricted region corresponding to a position, a shape, and a size of the detection region on the sample surface, and
wherein the controller configured to control the spatial light modulator to move the position of the random pattern image within a preset region such that the restricted region is included within the random pattern image formed on the image surface.

4. The wafer inspection apparatus of claim 2, wherein the controller configured to control the spatial light modulator to move the position of the random pattern image laterally during a first period among a plurality of periods, and
wherein the controller configured to control the spatial light modulator to move the position of the random pattern image vertically based on the first period ending and a second period subsequent to the first period starting.

5. The wafer inspection apparatus of claim 4, wherein the controller configured to control the spatial light modulator to move the position of the random pattern image n laterally by a first distance,
wherein the controller configured to control the spatial light modulator to move the position of the random pattern image vertically by a second distance, and
wherein the first distance and the second distance are determined based on an autocorrelation function of the random pattern image.

6. The wafer inspection apparatus of claim 2, wherein the random pattern image is provided at a plurality of positions on the image surface, and
wherein the controller is further configured to:
control the detector to acquire a plurality of diffraction images respectively corresponding to the plurality of positions; and
map and store the plurality of diffraction images and information about the plurality of positions.

7. The wafer inspection apparatus of claim 2, wherein the spatial light modulator comprises a plurality of light modulation pixels, and
wherein the controller is configured to control the spatial light modulator to arbitrarily assign a phase modulation value to each light modulation pixel among the plurality of light modulation pixels in a region corresponding to the position of the random pattern image.

8. The wafer inspection apparatus of claim 7, wherein the controller is configured to control the spatial light modulator to arbitrarily assign an amplitude modulation value to each light modulation pixel of the plurality of light modulation pixels in the region corresponding to the position of the random pattern image.

9. The wafer inspection apparatus of claim 1, wherein the wafer comprises a periodic pattern on a surface thereof.

10. The wafer inspection apparatus of claim 1, wherein the first light output from the light source comprises at least one of ultraviolet light, extreme ultraviolet light, X-rays, and visible light.

11. A wafer inspection apparatus comprising:
a light source configured to output first light;
a spatial light modulator behind an image surface and configured to receive the first light and output second light in a random pattern;
a beam splitter in a first light path from the light source to the spatial light modulator and configured to transmit the second light toward a wafer behind a sample surface;
an objective lens configured to focus the second light from the beam splitter onto an illuminated region of the wafer; and
a detector behind a detection surface and configured to acquire a diffraction image formed on the detection surface based on focused third light reflected from a detection region of the wafer,
wherein each of the sample surface, the detection surface, and the image surface is a virtual plane that is set in a direction perpendicular to a traveling direction of the second light,
wherein the image surface is in a second light path from the spatial light modulator to the beam splitter, and
wherein the second light that is in the random pattern forms a random pattern image of a same shape on each of the sample surface, the detection surface, and the image surface.

12. The wafer inspection apparatus of claim 11, wherein the image surface comprises a restricted region corresponding to a position, a shape, and a size of the detection region on the sample surface,
wherein the wafer inspection apparatus further comprises a controller configured to control the spatial light modulator to move a position of the random pattern image on the image surface within a preset region such that the restricted region is included within the random pattern image formed on the image surface, and
wherein the illuminated region of the wafer and the detection region within the illuminated region are not changed while the position of the random pattern image is moved.

13. The wafer inspection apparatus of claim 12, wherein the controller is configured to control the spatial light modulator to move the position of the random pattern image laterally during a first period among a plurality of periods, and
wherein the controller is further configured to control the spatial light modulator to move the position of the random pattern image vertically based on the first period ending and a second period subsequent to the first period starting.

14. The wafer inspection apparatus of claim 13, wherein the controller is configured to control the spatial light modulator to move the position of the random pattern image laterally by a first distance,
wherein the controller is further configured to control the spatial light modulator to move the position of the random pattern image vertically by a second distance, and
wherein the first distance and the second distance are determined based on an autocorrelation function of the random pattern image.

15. The wafer inspection apparatus of claim 12, wherein the random pattern image is provided at a plurality of positions on the image surface, and
wherein the controller is further configured to:
control the detector to acquire a plurality of diffraction images respectively corresponding to the plurality of positions, and
map and store the plurality of diffraction images and information about the plurality of positions, respectively.

16. The wafer inspection apparatus of claim 11, wherein the random pattern image comprises a speckle pattern image, and
wherein the first light output from the light source comprises at least one of ultraviolet light, extreme ultraviolet light, X-rays, and visible light.

17. The wafer inspection apparatus of claim 11, wherein the wafer comprises a periodic pattern on a surface thereof.

18. A wafer inspection apparatus comprising:
a light source;
a stage configured to fix a wafer that is behind a sample surface and that comprises a periodic pattern formed on a surface thereof;
a spatial light modulator behind an image surface and configured to receive first light from the light source and output second light in a random pattern;
a beam splitter in a first path of the second light and configured to transmit the second light toward the wafer;
an objective lens configured to focus the second light onto an illuminated region of the wafer; and
a detector behind a detection surface and configured to acquire a diffraction image formed on the detection surface based on focused third light reflected from a detection region of the wafer,
wherein each of the sample surface, the detection surface, and the image surface is a virtual plane set in a direction perpendicular to a traveling direction of the second light in the random pattern,
wherein the image surface is in a second light path from the spatial light modulator to the beam splitter, and
wherein the second light that is in the random pattern forms a random pattern image of a same shape on each of the sample surface, the detection surface, and the image surface.

19. The wafer inspection apparatus of claim 18, wherein the image surface comprises a restricted region corresponding to a position, a shape, and a size of the detection region on the sample surface,
wherein the wafer inspection apparatus further comprises a controller configured to control the spatial light modulator to move a position of the random pattern image on the image surface within a preset region such that the restricted region is included within the random pattern image formed on the image surface, and
wherein the illuminated region and the detection region are not changed while the position of the random pattern image is moved.

20. The wafer inspection apparatus of claim 19, wherein the controller is configured to control the spatial light modulator to move the position of the random pattern image n times laterally by a first distance during a first period among a plurality of periods,
wherein the controller is further configured to control the spatial light modulator to move the position of the random pattern image vertically by a second distance based on the first period ending and a second period subsequent to the first period starting, and
wherein the first distance and the second distance are determined based on an autocorrelation function of the random pattern image.
